(19) United States
(12) Patent Application Publication
(10) Pub. No.: US 2025/0379943 A1
(43) Pub. Date: Dec. 11, 2025

(54) INFORMATION PROCESSING APPARATUS, METHOD FOR CONTROLLING THE INFORMATION PROCESSING APPARATUS, AND STORAGE MEDIUM

(71) Applicant: CANON KABUSHIKI KAISHA, Tokyo (JP)

(72) Inventor: YOSHIHIDE TERAO, Kanagawa (JP)

(21) Appl. No.: 19/228,956

(22) Filed: Jun. 5, 2025

(30) Foreign Application Priority Data
Jun. 10, 2024 (JP) 2024-093657

(51) Int. Cl. H04N 1/00; H04N 1/32

(52) U.S. Cl. CPC H04N 1/00029; H04N 1/00408; H04N 1/00477; H04N 1/0048; H04N 1/32101; H04N 1/32641; H04N 2201/3202

(57) ABSTRACT

An object is to improve convenience for a user in a case where an error diagnosis is performed in an information processing apparatus performing a data transmission process. In order to achieve this object, in display control of a GUI (graphical user interface) to perform diagnosis processing for identifying a cause of a failure in regard to a job of data transmission which fails to be performed, screen display in the GUI is controlled so that the user can recognize a job which is a target of the diagnosis processing.

### BACKGROUND

### Field

The present disclosure relates to an error diagnosis technique in an information processing apparatus.

### Description of the Related Art

A multifunction peripheral provided with a plurality of functions such as a copy, FAX, a scan, and printing is widely used, and as a technique in a case of dealing with an error occurring in a case of the use of each function, for example, a technique disclosed in Japanese Patent Laid-Open No. 2018-86842 exists. Japanese Patent Laid-Open No. 2018-86842 discloses a technique of improving convenience for a user in a case of the dealing with an abnormality by displaying a shortcut to a setting operation screen to deal with the abnormality on a UI screen displaying the history of various abnormalities (errors) in a multi-function peripheral for each abnormality.

Some multifunction peripherals are provided with a data transmission function called “SEND function.” The SEND function is a function in which scanning is performed by a main body operation without using a scanner driver of a personal computer and external transmission of obtained scan image data can be performed. On the other hand, an information processing apparatus provided with a function of performing a diagnosis by using information on a job is proposed. In this diagnosis function, an appropriate job is required to be selected.

In a case of the use of the data transmission function, there may be a case where a transmission error occurs because of various factors, for example, an authentication failure at an external server and a false input of a host name at the external server. Further, some transmission errors include one which is treated as an error as a transmission result but whose cause of the error is clear and for which there is no particular remedy, for example, a case where a user who has noticed that a transmission destination is wrong cancels the transmission. Accordingly, a job which can be used for the diagnosis function and a job which cannot be used exist depending on the type of errors. In a case where the diagnosis function concerning the data transmission function is used, the user finds difficulty in confirming which job is suitable for the diagnosis.

### SUMMARY

An object of the present disclosure is to improve convenience for a user in a case where diagnosis processing for an error occurring in a case of use of a data transmission function is performed.

An information processing apparatus according to the present disclosure has a transmission processing unit configured to perform data transmission to an external apparatus, a storage unit configured to store history information indicating an execution result of a job of the data transmission, a diagnosis processing unit configured to perform diagnosis processing for identifying a cause of a failure in regard to the job of the data transmission which has failed to be performed, and a control unit configured to perform display control of a GUI (graphical user interface), wherein the control unit controls screen display in the GUI so that a user can recognize a job which is a target of the diagnosis processing out of jobs included in the history information.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration;

FIG. 2 is a block diagram illustrating an example of an internal configuration of a controller unit;

FIG. 3 is a block diagram illustrating an example of an internal configuration of a file server and a mail server;

FIG. 4 is a block diagram illustrating an example of a logical configuration of the controller unit;

FIGS. 5A and 5B are diagrams illustrating an example of a data structure of a table-format job history;

FIG. 6A is a diagram illustrating an example of a job history screen, FIG. 6B is a diagram illustrating an example of a job list screen, and FIG. 6C is a diagram illustrating an example of a diagnosis result screen;

FIG. 7 is a flow chart illustrating a flow of an operation control in a case where error diagnosis processing is performed according to Embodiment 1;

FIG. 8 is a diagram illustrating an example of an error selection screen;

FIG. 9 is a flow chart illustrating a flow of an operation control in a case where error diagnosis processing is performed according to Embodiment 2; and

FIG. 10 is a diagram illustrating a job list screen.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

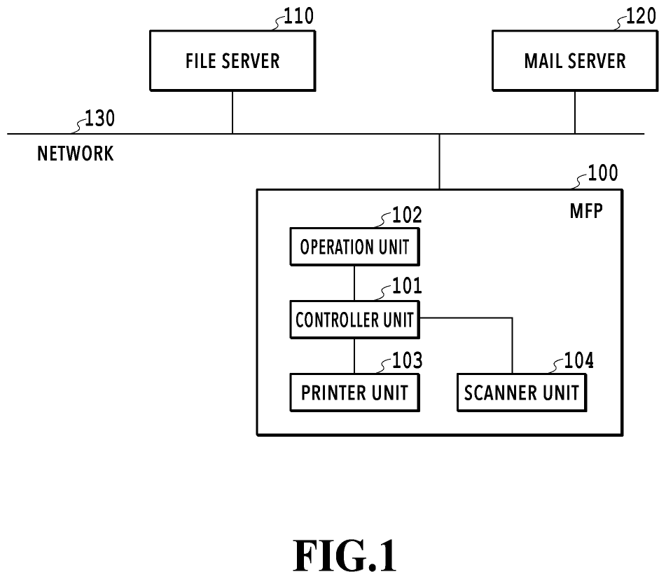

FIG. 1 is a diagram illustrating an example of a system configuration of the present embodiment. A system in the present embodiment includes a multifunction peripheral (hereinafter described as “MFP”) 100 having functions of a copy, a scan, printing, and data transmission, a file server 110, and a mail server 120. The MFP 100, the file server 110, and the mail server 120 are connected to each other via a network 130. The network 130 may use wired connection or wireless connection, and the network 130 may be the Internet or an intranet. The network 130 may take any form as long as data communication can be performed between the MFP 100 and the servers 110 and 120. Furthermore, the MFP 100 may have other functions (for example, a FAX function or a data storing function [also referred to as “BOX storage”]).

The MFP 100 has a controller unit 101, an operation unit 102, a printer unit 103, and a scanner unit 104. The operation unit 102, the printer unit 103, and the scanner unit 104 realize respective functions according to control performed by the controller unit 101. The operation unit 102 is a user interface on which a user performs various operations and which includes a display used for a GUI and hardware keys. The printer unit 103 performs a printing process based on image data. The scanner unit 104 optically reads a document placed on a document positioning plate (not illustrated) or the like and converts the document into image data.

### (MFP Hardware Configuration)

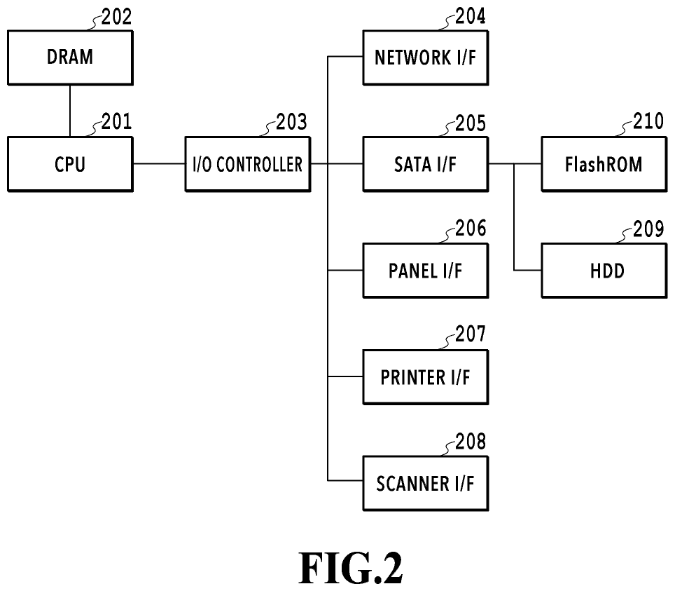

FIG. 2 is a block diagram illustrating an example of an internal configuration of the controller unit 101 of the MFP 100 which is an information processing apparatus. A CPU 201 is an arithmetic processing apparatus which executes various programs and takes charge of entire control. The CPU 201 is connected to a DRAM 202 and an I/O controller 203 via a bus. The DRAM 202 is a working memory temporarily storing the programs executed by the CPU 201 and data in the middle of calculation. The I/O controller 203 receives input from and provides output to various devices according to an instruction of the CPU 201. The I/O controller 203 is connected to a network I/F 204, a SATA (Serial Advanced Technology Attachment) I/F 205, a panel I/F 206, a printer I/F 207, and a scanner I/F 208. Further, a flash ROM 210 and an HDD 209 are connected to the SATA (Serial Advanced Technology Attachment) I/F 205. The flash ROM 210 and the HDD 209 are nonvolatile storage media to store a program to realize the function of the MFP 100 and a document file or the like. The network I/F 204 is connected to a wired LAN device and a wireless LAN device, and the CPU 201 realizes communication over the network 130 by controlling the wired LAN device and the wireless LAN device via the network I/F 204. Further, the CPU 201 realizes a GUI (graphical user interface) in the operation unit 102 via the panel I/F 206. Furthermore, the CPU 201 realizes a printing process in the printer unit 103 via the printer I/F 207.

In the MFP 100, applications to use respective functions exist. For example, in a case where a copy function is performed, the CPU 201 reads an application program for copying from the flash ROM 210 via the SATA I/F 205 into the DRAM 202. The CPU 201 follows the program read into the DRAM 202 and detects a copy instruction from the user to the operation unit 102 via the panel I/F 206. In a case where the CPU 201 detects the copy instruction, the CPU 201 controls the scanner unit 104 via a scanner I/F 208, causes the scanner unit 104 to read the document placed on the document positioning plate (not illustrated), receives a read result as image data, and stores the image data in the DRAM 202. Further, the CPU 201 performs a color conversion process or the like in which the color of the image data stored in the DRAM 202 is converted into a color suitable for a printing process and transfers the converted image data to the printer unit 103 via the printer I/F 207. Further, the printer unit 103 performs a printing process based on the image data. In addition, in a case where a data transmission function (SEND function) is performed, for example, the CPU 201 reads an application program for data transmission from the Flash ROM 210 into the DRAM 202 via the SATA I/F 205. The CPU 201 follows the program read by the DRAM 202 and detects a transmission instruction from the user to the operation unit 102 via the panel I/F 206. This transmission instruction includes a transmission protocol, transmission destination information, an image format or the like. The transmission protocol includes SMB and FTP or the like, and the transmission destination information is designated by UNC (Universal Naming Convention), for example. The image format includes JPEG and PDF or the like. The CPU 201 controls the scanner unit 104 via the scanner I/F 208 in a case where the CPU 201 detects the transmission instruction, causes the scanner unit 104 to read a document placed on the document positioning plate (not illustrated), receives a read result as image data, and stores the image data in the DRAM 202. Further, the CPU 201 performs a conversion process of converting the image data stored in the DRAM 202 into a designated image format or the like, and transfers the image data to a transmission destination designated by a designated transmission protocol via the network I/F 204.

### (Hardware Configuration of a Server)

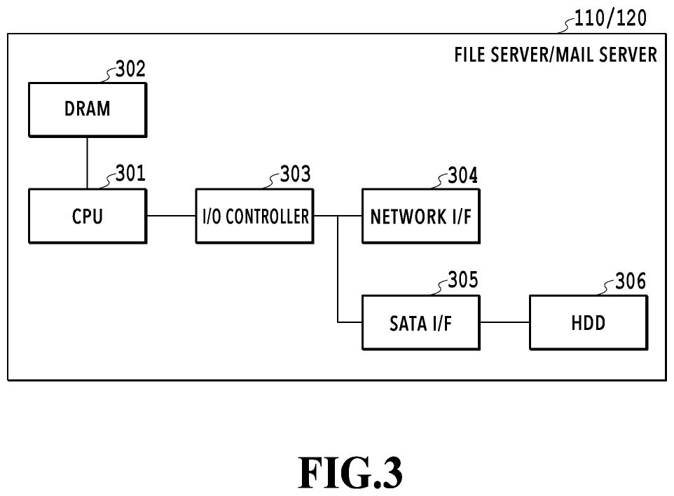

FIG. 3 is a block diagram illustrating an example of an internal configuration of the file server 110 and the mail server 120. In the present embodiment, for the sake of simplifying an explanation, the file server 110 and the mail server 120 have an identical internal configuration but may have a different configuration. The CPU 301 is an arithmetic processing apparatus which executes various programs and takes charge of entire control. The CPU 301 is connected to a DRAM 302 and an I/O controller 303 via a bus. The DRAM 302 is a working memory temporarily storing a program to be executed by the CPU 301 and data in the middle of computation or the like. The I/O controller 303 follows an instruction of the CPU 301 and receives input from and provides output to various devices. A network I/F 304 and an SATA (Serial Advanced Technology Attachment) I/F 305 are connected to the I/O controller 303. Furthermore, an HDD 306 is connected to the SATA (Serial Advanced Technology Attachment) I/F 305. A wired LAN device and a wireless LAN device are connected to the network I/F 304, and the CPU 301 realizes communication over the network 130 by controlling the wired LAN device and the wireless LAN device via the network I/F 304. Further, the CPU 301 executes a program relating to a process of storing and reading a file in a case of the file server 110 and executes a program relating to a process of sending and receiving mail in a case of the mail server 120. In the present embodiment, for the sake of simplifying an explanation, one CPU 301 performs various processes illustrated in a flow chart described below by using a memory (DRAM 302), but the configuration of a server is not limited to this. For example, the configuration of the server may be realized by causing a plurality of processors, a RAM, a ROM, and a storage to cooperate. Further, the configuration of the server may be realized by using a plurality of server computers.

### (Software Configuration)

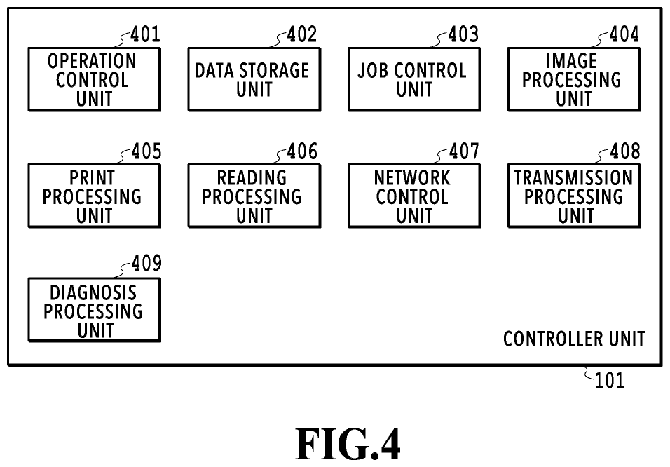

FIG. 4 is a block diagram illustrating an example of a software configuration (logical configuration) of the controller unit 101 of the MFP 100. The controller unit 101 illustrated in FIG. 4 has an operation control unit 401, a data storage unit 402, a job control unit 403, an image processing unit 404, a print processing unit 405, a reading processing unit 406, a network control unit 407, a transmission processing unit 408, and a diagnosis processing unit 409. The function of each block illustrated in FIG. 4 is realized as a result of the CPU 201 developing a predetermined program in the DRAM 202 and executing this. Hereinafter, each block is described.

The operation control unit 401 performs control regarding the operation unit 102 such as display control of various kinds of user interface screens (UI screens) used in the GUI and detection of various operations performed by the user on the UI screen. The data storage unit 402 performs, based on a request from other control units and processing units, a process of storing data in the HDD 209 and the flash ROM 210 or reading out data from the HDD 209 and the flash ROM 210.

The job control unit 403 controls the performance of functions of a copy, a scan, printing, and data transmission which the MFP 100 has. Each function is performed in units of “jobs.” For example, in a case where a data transmission function is performed, a job (hereinafter, described as “SEND job”) used for data transmission including a transmission protocol, transmission destination information, and an image format or the like is generated according to the transmission instruction mentioned above, and a data transmission process is performed according to the SEND job.

The image processing unit 404 processes the image data into an image format suitable for a use according to an instruction from the job control unit 403. The printing processing unit 405 prints an image on a sheet and does output via the printer I/F 207 according to an instruction from the job control unit 403. The reading processing unit 406 generates image data by performing a process of optically reading the document placed on the document positioning plate via the scanner I/F 208 according to an instruction from the job control unit 403.

The network control unit 407 receives input of and provides output of data via a LAN and a public line by using the network I/F 204 according to an instruction from another control unit or process unit. Further, the network control unit 407 enables the image data or the like stored in the flash ROM 210 or the HDD 209 to be accessed from an external device. The transmission processing unit 408 performs a data transmission process of transmitting the image data or the like generated by the reading processing unit 406 to the file server 110 or the mail server 120 via the network control unit 407 based on the SEND job from the job control unit 403. Further, the transmission processing unit 408 associates the execution result of the data transmission process with the SEND job thereof and stores the execution result as a job history in the HDD 209 via the data storage unit 402. Stored data on the job history is referred to in error diagnosis processing performed by a diagnosis processing unit 409 mentioned below.

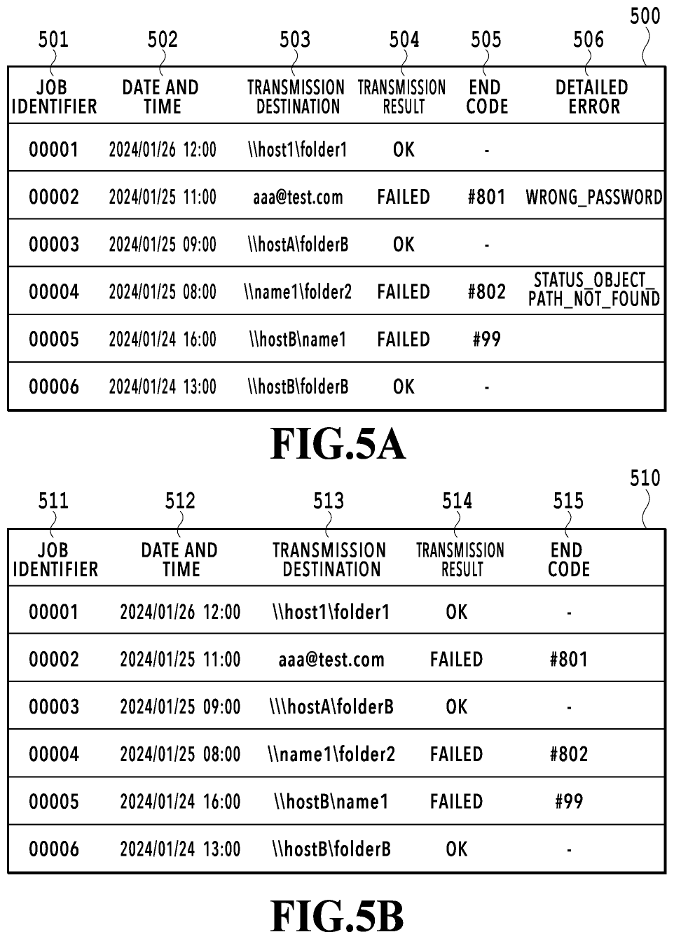

FIG. 5A is a diagram illustrating an example of a data structure of a table-format job history. A job history table 500 illustrated in FIG. 5A is composed of six items 501 to 506. A “job identifier” 501 indicates a unique number to uniquely identify the SEND job. A “date and time” 502 indicates a date and time on which the SEND job is performed. A “transmission destination” 503 indicates information on an e-mail address and a folder path of a transmission destination designated in the SEND job. A “transmission result” 504 is information representing whether the execution result of the SEND job is successful (OK) or failed (failure). An “end code” 505 is code information representing an outline of a cause in a case where the job does not normally end. The end code of the present embodiment is composed of a combination of the symbol “#” and a three-digit number. Here, in a record in which the job identifier 501 is “00002,” the value of the end code 505 is “#801.” The symbol “#801” indicates that communication with a destination mail server cannot be established because authentication fails for any reason. Further, in a record in which the job identifier 501 is “00004,” the value of the end code 505 is “#802.” The symbol “#802” indicates that the image data cannot be transmitted to a destination file server for any reason after the establishment of communication. Furthermore, in a record in which the job identifier 501 is “00005,” the value of the end code 505 is “#99.” The symbol “#99” indicates that the performance of the SEND job is canceled on the user's own. A detailed error 506 is error detailed information indicating details of the cause of the failure of the data transmission process, and a character string or the like obtained from a server of the destination to which the transmission data is transmitted is entered therein. Here, the value of the detailed error 506 in the record in which the job identifier 501 is “00002” is the character string “WRONG_PASSWORD” returned from the mail server 120 of the destination. In this case, the character string indicates that reception fails because a password for authentication is wrong. Further, the value of the detailed error 506 in the record in which the job identifier 501 is “00004” is the character string “STATUS_OBJECT_PATH_NOT_FOUND” returned from the file server 110 of the destination. In this case, the character string indicates that the reception has failed because a folder path designated as a data storing destination does not exist. These values of the detailed error 506 make it possible to know details on error causes of the data transmission process. Here, in the record in which the job identifier 501 is “00005,” the symbol “#99” is entered as the value of the end code 505, but the detailed error 506 is blank and no value is entered. This is because whether to add a job to a job list mentioned below is determined by whether a value is entered in the detailed error 506 (that is, if a value is entered, the job is added, and if a value is not entered, the job is not added). As mentioned above, the symbol “#99” is an end code which means that the performance of the SEND job is canceled on the user's own, and the reason that the data transmission process fails is clear without the need for diagnosis, and thus there is no solution thereto. Then, in a case where the value of the end code is “#99,” even in a case where information is received from the server of the destination (it is possible that any character string or the like is returned depending on the timing of a cancel operation of the SEND job), the detailed error 506 is made blank. Incidentally, a value to be entered in the detailed error 506 is uniquely defined at the destination server's side as mentioned above. Thus, for example, in a case where, the value to be entered in the detailed error 506 is defined by a number sequence such as “535 5.7.8” instead of the character string “WRONG_PASSWORD,” the number sequence is entered as the value of the detailed error 506. Further, even in a case of an end code other than the above end code which means the cancel performed on the user's own, the value of the detailed error 506 may remain blank in a case where there is no need to add a job to the job list.

In regard to the job in which the performance of the data transmission process fails, the diagnosis processing unit 409 performs the error diagnosis processing for identifying the cause of the failure based on data on the job history mentioned above.

### <Operation Control Relating to Error Diagnosis Processing>

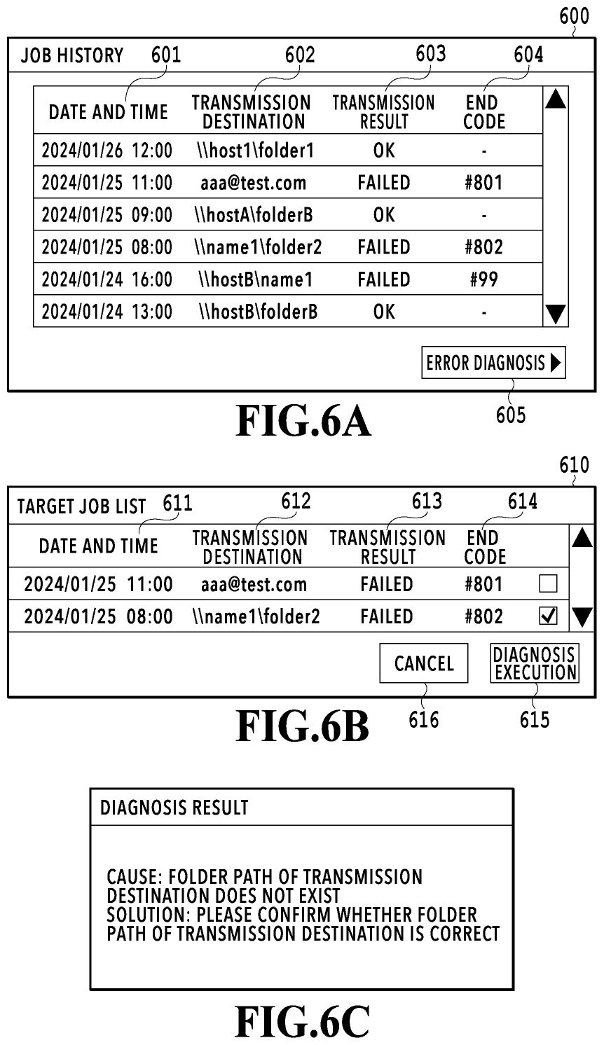

The user can perform the error diagnosis processing targeted for a predetermined job via a job history screen as illustrated in, for example, FIG. 6A. A detailed explanation is made below.

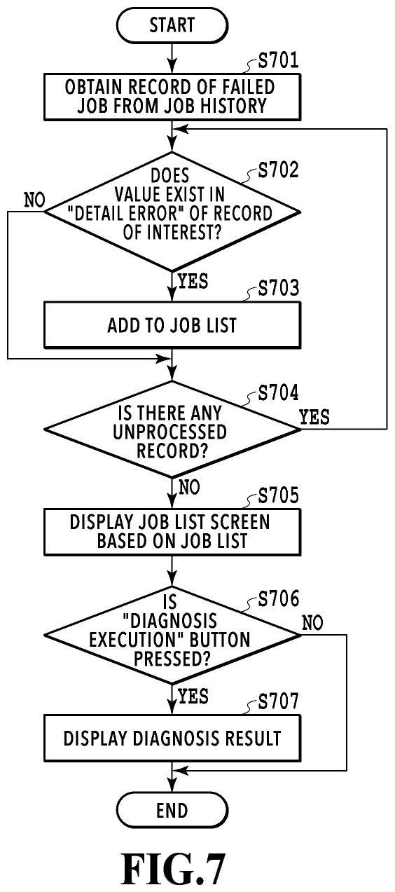

FIG. 6A is an example of the job history screen based on the job history table 500 of FIG. 5A mentioned above, and such a UI screen is displayed on the operation unit 102 by the operation control unit 401. In a job history screen 600 of FIG. 6A, items 601 to 604 correspond to the items 502 to 505 in the job history table 500 of FIG. 5A, and each item value of the job history table 500 is displayed. Here, there is no item corresponding to the detailed error 506 of the job history table 500 in the job history screen 600. The reason is that the value of the detailed error 506 is defined at the destination server's side as mentioned above and there is a case where the value of the detailed error 506 is, for example, a number sequence or the like and thus even in a case where the value of the detailed error 506 is included in the UI screen, the user cannot always understand the value of the detailed error 506. Of course, the item corresponding to the detailed error 506 may be provided in the job history screen 600 as well. Further, for example, a configuration in which a instruction to start the error diagnosis processing is accepted via another kind of UI screen such as a maintenance screen may be provided. In a case where a press of an “error diagnosis” button 605 in the job history screen 600 is detected, a series of processes illustrated in a flow chart of FIG. 7 starts. Hereinafter, a detailed explanation is made with reference to the flow chart of FIG. 7. Incidentally, the symbol “S” means a step in the following explanation.

In S701, information on a job in which the value of a “transmission result” 603 is “FAILED” of jobs listed and displayed on the job history screen 600 (hereinafter described as “failed job”) is obtained. Here, the second job, the fourth job, and the fifth job from the top are jobs in which the value of the “transmission result” 603 is “FAILED” in the job history screen 600. Therefore, the respective records whose values of the job identifier 501 are “00002,” “00004,” and “00005” corresponding to these jobs are obtained from the job history table 500.

Whether error detailed information is included in a record of interest of records of the failed jobs obtained in S701 (that is, whether a value is entered in the “detailed error” 506) is determined in S702, and a process to be performed next is allocated according to a determination result. As a result of the determination, in a case where a value is entered in the detailed error 506, S703 is performed next, and the failed job of the record of interest is added to a job list. Here, the job list is a list indicating a failed job to be included in a job list screen mentioned below. On the other hand, in a case where no value is entered in the detailed error 506, S704 is performed next, and whether processes of all records of the failed jobs obtained in S701 are completed or not is determined. In a case where there is a record of an unprocessed failed job, the process returns to S702 and continues. On the other hand, in a case where the processes of all the records of the failed jobs are completed, S705 is performed next.

In S705, a UI screen (job list screen) illustrating a list of jobs to be targets of the error diagnosis processing is displayed on the operation unit 102 by the operation control unit 401 based on the job list obtained from the performed processes. FIG. 6B is an example of a job list screen 610 having items 611 to 614 similar to the items 601 to 604 of the job history screen 600 as mentioned above. Here, only jobs in which the value of the “transmission result” 603 is “FAILED” and the values of the “end code” 604 are “#801” and “802” in the job history screen 600 are displayed on the job list screen 610. The reason why the failed job in which the value of the “end code” 604 is “#99” is not displayed on the job history screen 600 is that the failed job does not have a value in the detailed error 506 of the job history table 500. Further, a check box to select a job of which the user desires to perform the error diagnosis processing exists in each record in the job list screen 610. The user places a checkmark in a check box corresponding to a desired job and presses a “diagnosis execution” button 615. Here, in the job list screen 610, a check box of a record whose value of the “end code” 614 is “#802” is checked. In a case where a user's press operation of the “diagnosis execution” button 615 which is an instruction to start performing the error diagnosis processing is detected in this state, error diagnosis processing of the failed job whose value of the “end code” 614 is “#802” is performed.

S706 is a detection process of detecting a press of the operation button performed by the user. In a case where the press of the “diagnosis execution” button 615 is detected, S707 is performed next. On the other hand, in a case where a press of a “cancel” button 616 is detected, the present process is exited.

In S707, the error diagnosis processing of the failed job selected by the user is performed by the diagnosis processing unit 409, and a diagnosis result screen is displayed by the operation control unit 401 on the operation unit 102. The error diagnosis processing is performed based on the value of the “detailed error” 506 of the record concerning the selected failed job obtained in S701. FIG. 6C is an example of a diagnosis result screen in a case where the record whose value of the “end code” 614 is “#802” is selected in the job list screen 610 as mentioned above. Here, in the record, the character string “STATUS_OBJECT_PATH_NOT_FOUND” is entered as the value of the “detailed error” 506. Base on this, messages indicating as an error cause that a folder path of a transmission destination does not exist and indicating as a solution that whether the folder path of the transmission destination is designated or not must be confirmed are displayed. The user can know the cause of failure of the selected SEND job and a solution thereto.

The above is the contents of a series of processes according to the present embodiment in a case where the error diagnosis is performed. In the present embodiment, an aspect in which the screen display is controlled so that a failed job which is not a target of the error diagnosis is not included in the job list screen is explained, but control of screen display such that a similar effect can be achieved while display is performed with the failed job included may be performed. Hereinafter, an aspect in which a similar effect is obtained while the failed job which is not the target of the error diagnosis is included in the job list screen is explained as a modification example.

### Modification Example 1

The failed job which is not the target of the error diagnosis may also be displayed on the job list screen, and in a case where the failed job is selected, the user may be prevented from pressing the “diagnosis execution” button 615 by graying out the “diagnosis execution” button 615, or the like. In this case, in a case (S703) of the creation of the job list mentioned above, a flag value or the like indicating whether a job is the job which is the target of the error diagnosis is added. In other words, a flag value indicating being a target of the error diagnosis is added to the failed job in which the value is entered in the “detailed error” 506, and a flag value indicating not being a target of the error diagnosis is added to the failed job in which no value is entered. Further, display control as to whether to gray out the “diagnosis execution” button 615 based on the flag values has only to be performed.

### Modification Example 2

The failed job which is not the target of the error diagnosis may also be displayed on the job list screen, and even in a case where the failed job is selected and the “diagnosis execution” button 615 is pressed, the error diagnosis may not be performed. Further, a notification that a selected failed job is the failed job for which the error diagnosis cannot be performed is provided to the user by displaying a message that the selected failed job is not a target of the error diagnosis, or the like. As in the modification example 1 mentioned above, this case is also feasible by adding a flag value indicating whether a job is a target of the error diagnosis in the case (S703) of the creation of the job list.

### Modification Example 3

Display control may be performed such that the user cannot select the failed job which is not the target of the error diagnosis while the failed job which is not the target of the error diagnosis is included in the job list screen by graying out the failed job which is not the target of the error diagnosis in a case where the failed job which is not the target of the error diagnosis is displayed on the job list screen. As in the modification examples 1 and 2 mentioned above, this case is feasible by adding a flag value indicating whether a job is a target of the error diagnosis in the case (S703) of the creation of the job list.

### Modification Example 4

A failed job (a job in which a value is entered in the “detailed error” 506) which is a target of the error diagnosis may be made noticeable in the job list screen by highlighting the failed job, or the like. The user can thereby easily recognize which is the job which can be the target of the error diagnosis even in a case where the failed job which is the target of the error diagnosis and the failed job which is not the target of the error diagnosis are mixed and displayed on the job list screen.

The user can understand from each modification example mentioned above that the job is not the target of the error diagnosis, and thus an effect equivalent to that of the present embodiment can be obtained.

As mentioned above, according to the present embodiment, convenience for the user in a case where the error diagnosis of the SEND job which has failed to be performed is performed can be improved.

### Second Embodiment

In Embodiment 1, the failed job to be displayed on the job list screen is limited to the one which has detailed information on the error cause. Next, an explanation is made on the premise that an aspect which limits the failed job to be displayed on the job list screen to one which has the detailed information on an error cause and which matches an error content selected by the user in advance is Embodiment 2. A system configuration and hardware and software configurations of the MFP or the like are basically identical to those of Embodiment 1, and thus an explanation centering on the differences between Embodiment 1 and Embodiment 2 is made below.

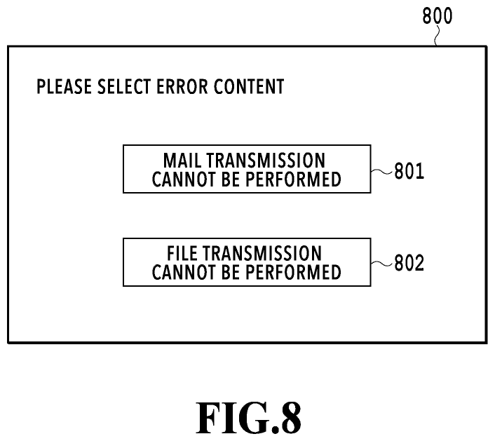

Error diagnosis processing according to the present embodiment is started based on a user instruction via an error selection screen in which error contents (error types) as illustrated in FIG. 8, for example, are selected. Here, a button 801 indicating that mail transmission cannot be performed and a button 802 indicating that file transmission cannot be performed exist in an error selection screen illustrated in FIG. 8. In this case, in a case where the user presses the button 801, only failed jobs relating to e-mail transmission are displayed on the job list screen, and in a case where the user presses the button 802, only failed jobs relating to the file transmission are displayed on the job list screen.

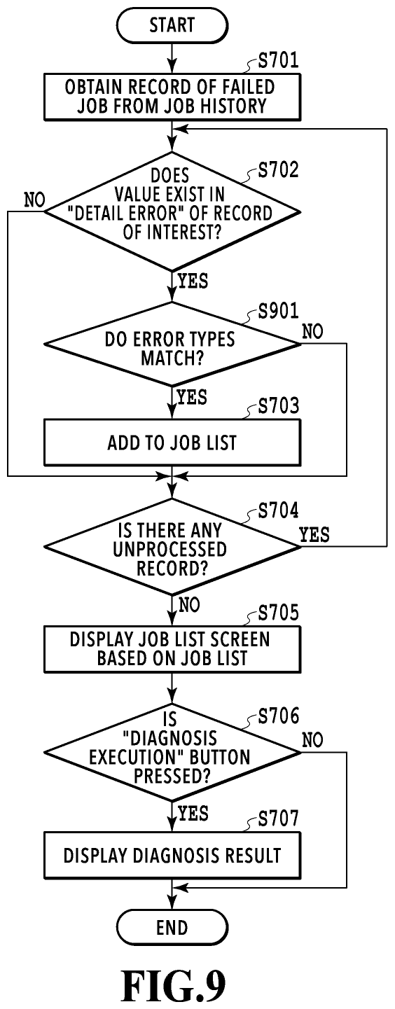

FIG. 9 is a flow chart illustrating a flow of a series of processes in a case where the error diagnosis is performed according to the present embodiment. A difference from the flow chart in FIG. 7 of Embodiment 1 is the addition of S901. Then, an explanation about a difference centering on S901 is made.

First, in a case where error detailed information is added to the record of interest (that is, a value is entered in the detailed error 506) (the answer is YES in S702), S901 is performed next.

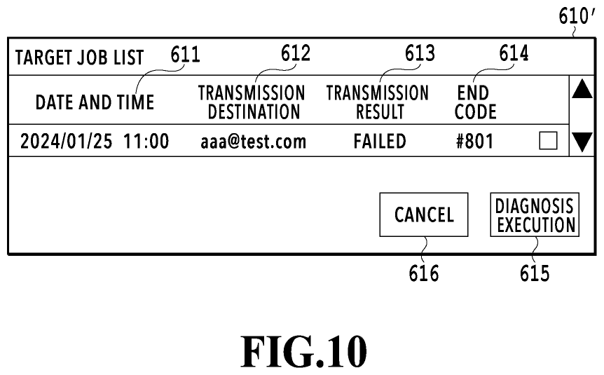

In S901, whether the error type of a record of interest corresponds to an error type selected by the user in the error selection screen is determined based on the value of the “transmission destination” 503 included in the record of interest, and a process to be performed next is allocated according to a determination result. As a result of the determination, in a case where the error type of the record of interest matches the error type selected by the user, a failed job of the record of interest is added to a job list (S703). Further, a job list screen is generated and displayed based on the job list finally obtained (S705). FIG. 10 illustrates a job list screen to be displayed in S705 in a case where the button 801 is pressed in the error selection screen 800 in FIG. 8 mentioned above. It is seen that on a job list screen 1000 of FIG. 10, only the failed job of the e-mail transmission is displayed and a failed job of the file transmission is not displayed.

In this way, according to the present embodiment, only the failed job corresponding to the error type selected in advance is displayed on the job list screen, and thus the user can efficiently perform an operation of the error diagnosis.

### Modification Example

In Embodiments 1 and 2, the MFP 100 which has the error diagnosis function allows the user to efficiently perform the error diagnosis by associating information returned from the destination server with the SEND job and storing the information in the job history in a case where the SEND job has failed to be performed. Here, a case where for example, an MFP which is a type which does not have the error diagnosis function (diagnosis processing unit 409) is upgraded to an MFP which is a type which has the error diagnosis function is considered. In this case, in regard to a SEND job to be performed after the upgrade, as mentioned above, information transmitted from the destination server in a case where the SEND job has failed to be performed is included in the job history and is stored. On the other hand, in regard to a SEND job performed before the upgrade, such storing of the job history is not performed. In other words, even in a case where the cause of the failure is the same, in regard to an error job before the upgrade, the “detailed error” 506 of the job history table 500 is blank, but in regard to an error job after the upgrade, a value is entered in the “detailed error” 506. Then, the error job before the upgrade is not added to the job list according to the flow of FIG. 7 mentioned above (the answer is NO in S702) and is controlled so as not to be displayed on the job list screen. This makes it possible to perform the error diagnosis processing after the upgrade, with the history information on the SEND job performed before the upgrade.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to improve the convenience for the user in a case where diagnosis processing of an error caused in a case of the use of a data transmission function is performed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-093657 filed Jun. 10, 2024 which is hereby incorporated by reference wherein in its entirety.

What is claimed is:

1. An information processing apparatus comprising:
one or more memories storing instructions; and
one or more processors executing the instructions to:
perform data transmission to an external apparatus;
store history information indicating an execution result of a job of the data transmission;
perform diagnosis processing for identifying a cause of a failure in regard to the job of the data transmission which fails to be performed; and
perform display control of a GUI (graphical user interface) so that a user can recognize a job which is a target of the diagnosis processing out of jobs included in the history information.

2. The information processing apparatus according to claim 1, wherein
in the display control,
a first screen including a job which is included in the history information, which is capable of being a target of the diagnosis processing, and which has failed to be performed and another job which is incapable of being the target of the diagnosis processing is displayed on a display unit;
a second screen on which the user selects the job which is the target of the diagnosis processing and provides an instruction to start execution of the diagnosis processing of the selected job is displayed on the display unit based on a user instruction via the first screen; and
the second screen is configured to accept the instruction to start the execution of the job which is capable of being the target of the diagnosis processing and which has failed to be performed but not to accept the instruction to start the execution of the other job which is incapable of being the target of the diagnosis processing.

3. The information processing apparatus according to claim 2, wherein
the second screen is configured so that the user cannot select the other job which is incapable of being the target of the diagnosis processing.

4. The information processing apparatus according to claim 3, wherein
the other job which is incapable of being the target of the diagnosis processing is grayed out on the second screen.

5. The information processing apparatus according to claim 2, wherein
the second screen does not display the other job which is incapable of being the target of the diagnosis processing.

6. The information processing apparatus according to claim 2, wherein
the second screen displays the job which is capable of being the target of the diagnosis processing and which has failed to be performed and the other job which is incapable of being the target of the diagnosis processing, but is configured so that the user cannot provide an instruction to start the execution of the diagnosis processing of the other job which is incapable of being the target of the diagnosis processing.

7. The information processing apparatus according to claim 6, wherein
in regard to the other job which is incapable of being the target of the diagnosis processing, a button used by the user to provide the instruction to start the execution of the diagnosis processing is grayed out on the second screen.

8. The information processing apparatus according to claim 2, wherein the second screen is configured so that the user can make the selection of a job in which an error type corresponds to an error content designated in advance out of the jobs which are capable of being the target of the diagnosis processing and which have failed to be performed.

9. The information processing apparatus according to claim 1, wherein
in the display control,
a first screen including a job which is included in the history information, which is capable of being a target of the diagnosis processing, and which has failed to be performed and another job which is incapable of being the target of the diagnosis processing is displayed on a display unit;
a second screen on which the user selects the job which is the target of the diagnosis processing and provides an instruction to start execution of the diagnosis processing of the selected job and on which the job which is capable of being the target of the diagnosis processing and which has failed to be performed and the other job which is incapable of the target of the diagnosis processing are displayed is displayed on the display unit based on a user instruction via the first screen;
in a case where the instruction to start the execution of the other job which is incapable of being the target of the diagnosis processing is accepted, a message indicating that the execution cannot be performed is displayed on the display unit; and
in a case where the message is displayed on the display unit, the diagnosis processing based on the instruction to start the execution is not performed.

10. The information processing apparatus according to claim 1, wherein
detailed information on a failure cause is added to the job which is capable of being the target of the diagnosis processing and which has failed to be performed out of jobs included in the stored history information; and
in the display control, screen display in the GUI is controlled so that the job to which the detailed information is added out of the jobs included in the history information is treated as a job which is capable of being a target of the diagnosis processing.

11. The information processing apparatus according to claim 10, wherein
the detailed information is information provided from the external apparatus in a case where the data transmission has failed to be performed.

12. The information processing apparatus according to claim 11, wherein the information provided from the external apparatus is information defined in the external apparatus.

13. A method for controlling an information processing apparatus performing data transmission to an external apparatus comprising the steps of:
storing history information indicating an execution result of a job of the data transmission;
performing display control of a GUI (graphical user interface) to perform diagnosis processing for identifying a cause of a failure in regard to the job of the data transmission which fails to be performed, wherein
in the display control, screen display in the GUI is controlled so that a user can recognize a job which is a target of the diagnosis processing out of jobs included in the history information.

14. A non-transitory computer readable storage medium storing a program for causing a computer to perform a method for controlling an information processing apparatus performing data transmission to an external apparatus comprising the steps of:
storing history information indicating an execution result of a job of the data transmission;
performing display control of a GUI (graphical user interface) to perform diagnosis processing identifying a cause of a failure in regard to the job of the data transmission which fails to be performed, wherein
in the display control, screen display in the GUI is controlled so that a user can recognize a job which is a target of the diagnosis processing out of jobs included in the history information.
